(19) United States
(12) Patent Application Publication
(10) Pub. No.: US 2026/0153727 A1
(43) Pub. Date: Jun. 4, 2026

(54) OPTICAL MODULE

(71) Applicant: TDK TAIWAN CORP., Taoyuan City (TW)

(72) Inventors: Yi-Ho CHEN, Taoyuan City (TW); Mao-Kuo HSU, Taoyuan City (TW); Ying-Jen WANG, Taoyuan City (TW); Yu-Chi KUO, Taoyuan City (TW); Sz-Hsuan LIU, Taoyuan City (TW)

(21) Appl. No.: 19/181,681

(22) Filed: Apr. 17, 2025

Related U.S. Application Data
(60) Provisional application No. 63/636,417, filed on Apr. 19, 2024.

(51) Int. Cl. G02B 27/00

(52) U.S. Cl. CPC G02B 27/0006

(57) ABSTRACT

An optical module is provided. The optical module includes a movable part, a fixed part, and a driving assembly. The movable part moves relative to the fixed part. The driving assembly is for driving the movable part to move relative to the fixed part. The optical module further includes an intermediate assembly, the movable part moves relative to the fixed part via the intermediate assembly. The intermediate assembly includes a first intermediate element and a second intermediate element. The first intermediate element is placed between a first surface of the fixed part and the movable part. The second intermediate element is placed between the second surface and the movable part.

### CROSS REFERENCE TO RELATED APPLICATIONS

This application claims the benefit of U.S. Provisional Application No. 63/636,417, filed 2024 Apr. 19, the entirety of which is incorporated by reference herein.

### BACKGROUND OF THE INVENTION

### Field of the Invention

The present invention relates to an optical module, and, in particular, it relates to an optical module with a movable part that moves relative to a fixed part via a first intermediate element and a second intermediate element.

### Description of the Related Art

With the development of technology, many electronic devices today (such as computers and tablets) have the function of taking photos and recording videos. The use of these electronic devices is becoming increasingly common, and while they have been developed to be more stable and have better optical quality, the design trend is also moving towards making them more convenient, with a slim profile, to provide users with more options.

Outdoor cameras play a crucial role in security surveillance, autonomous vehicles, and industrial monitoring. However, they are constantly exposed to dust, rain, mud, and other environmental contaminants that can obscure the lens and compromise image quality. Traditional cleaning methods, such as manual wiping or washing with liquid-based solutions, are impractical for outdoor applications and may cause wear and tear over time.

Also, when it is necessary to install optical elements (such as lenses) with long focal lengths into the aforementioned electronic devices, this results in an increase in the thickness of the electronic device, which is not advantageous to the slimming-down and stability of said electronic device. In view of this, designing an optical system that effectively removes dust, water droplets, and debris without the need for physical contact or additional cleaning has become an important issue.

### BRIEF SUMMARY OF THE INVENTION

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings and each claim.

According to an aspect of the present invention, an embodiment provides an optical module. The optical module includes a movable part, a fixed part, and a driving assembly. The movable part moves relative to the fixed part. The driving assembly is for driving the movable part to move relative to the fixed part.

According to certain aspects of the present invention, the fixed part includes an outer frame and a second surface. The first surface and the second surface face different directions. The optical module further includes an intermediate assembly. The movable part moves relative to the fixed part via the intermediate assembly. The intermediate assembly includes a first intermediate element and a second intermediate element. The first intermediate element is disposed between the first surface and the movable part. The second intermediate element is disposed between the second surface and the movable part. The fixed part further includes an outer frame and a housing base. The outer frame includes an opening corresponding to an optical axis. The first surface is formed on the outer frame. The second surface is formed on the housing base. The optical module further includes a gap between the outer frame and the movable part.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of exemplary embodiments together with reference to the accompanying drawings. These drawings depict only exemplary embodiments, and are therefore not to be considered as limitations on the scope of the various embodiments or claims.

FIG. 1 is a perspective view of an optical module, according to certain aspects of the present disclosure.

FIG. 2 is an exploded perspective view of the optical module, according to certain aspects of the present disclosure.

FIG. 3 is a perspective bottom view of the outer frame of the optical module, according to certain aspects of the present disclosure.

FIG. 4 is a perspective view of the housing base of the optical module, according to certain aspects of the present disclosure.

FIG. 5A is a cross-sectional view of the optical module along line B-B in FIG. 1, according to certain aspects of the present disclosure.

FIG. 5B is a top view of the optical module, according to certain aspects of the present disclosure, wherein the outer frame and the movable part are removed for illustrative purposes.

FIG. 6A is a cross-sectional view of another embodiment of the optical module along line B-B in FIG. 1, according to other aspects of the present disclosure.

FIG. 6B is a top view of the optical module, according to certain aspects of the present disclosure, wherein the outer frame and the movable part are removed for illustrative purposes.

FIG. 6C is a cross-sectional view of another embodiment of the optical module along line B-B in FIG. 1, according to other aspects of the present disclosure.

FIG. 7 is a cross-sectional view of another embodiment of the optical module along line B-B in FIG. 1, according to other aspects of the present disclosure.

### DETAILED DESCRIPTION OF THE INVENTION

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, may be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “housing base,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

It will be understood that, although the terms “first”, “second”, etc. may be used herein to describe various elements, layers and/or parts, these elements, layers and/or parts should not be referred to as such. The terms are limited and are only used to distinguish between different elements, layers and/or parts. Thus, a first element, layer and/or part discussed below could be termed a second element, layer and/or part without departing from the teachings of some embodiments of the present disclosure. In addition, for the sake of simplicity, terms such as “first” and “second” may not be used to distinguish different elements in the specification. Without departing from the scope defined in the appended patent application, the first element and/or the second element described in the claims are interpreted as any element consistent with the description in the specification.

It should be noted that the technical solutions provided in different embodiments below may be replaced, combined or mixed with each other to constitute another embodiment without violating the spirit of the present disclosure.

The following description is made for the purpose of illustrating the general principles of the invention and should not be taken in a limiting sense. The scope of the invention is best determined by reference to the appended claims.

The optical module disclosed herein is a lens cleaning module designed specifically for outdoor cameras. By utilizing controlled vibration movements, this module effectively removes dust, water droplets, and debris without the need for physical contact or additional cleaning agents. This ensures continuous and reliable operation in harsh environments, reducing maintenance costs and improving the longevity of outdoor camera systems.

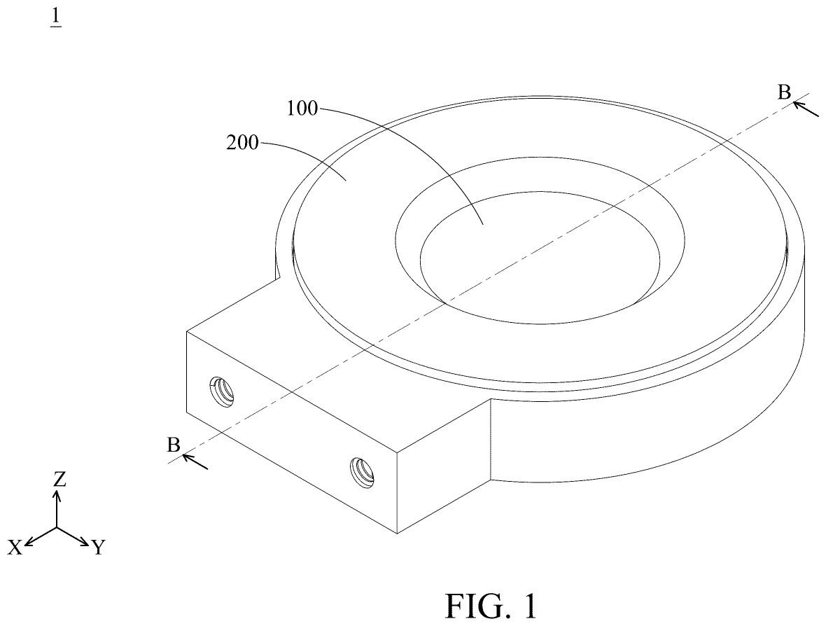

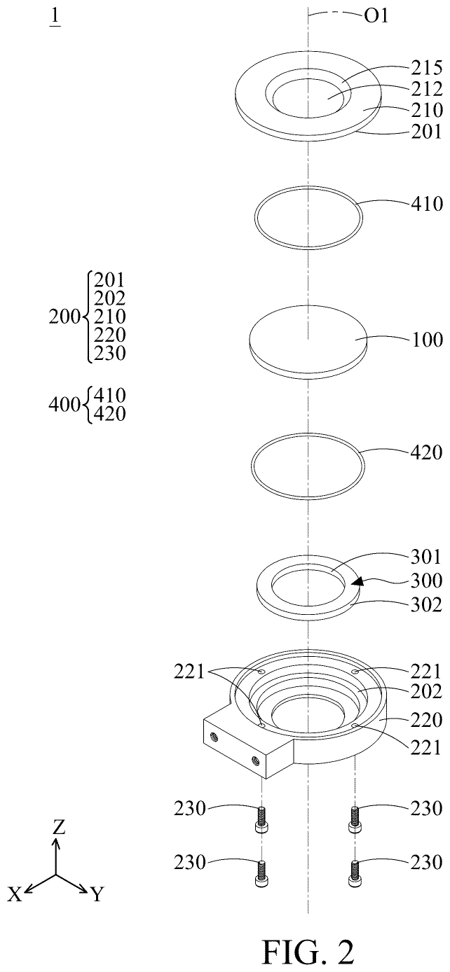

First, please refer to FIG. 1 and FIG. 2. FIG. 1 is a perspective view of an optical module 1, according to certain aspects of the present disclosure. FIG. 2 is an exploded perspective view of the optical module 1, according to certain aspects of the present disclosure.

The optical module 1 may be disposed on a lens driving device (not shown in figures), achieving autofocus (AF) and optical image stabilization (OIS) functions via the lens driving device, which has multiple driving circuit parts (not shown in figures) for driving the lens driving device.

The optical module 1 includes a movable part 100, a fixed part 200, a driving assembly 300, and an intermediate assembly 400. The movable part 100 may be, for example, an optical lens. The movable part 100 may move relative to the fixed part 200. The driving assembly 300 drives the movement of the movable part 100. The movable part 100 moves relative to the fixed part 200 via the intermediate assembly 400. The external incident light passes through the optical module 1 by an optical axis O1.

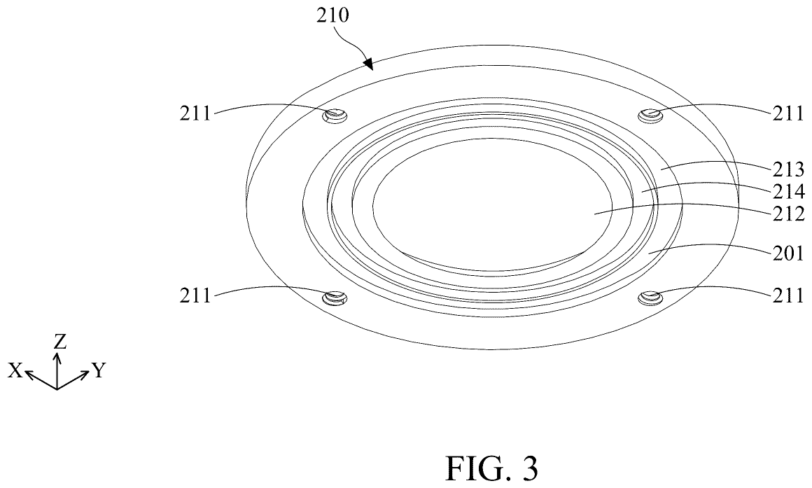

The fixed part 200 includes a first surface 201 (shown in FIG. 3), an outer frame 210, a housing base 220, a second surface 202, and a plurality of connecting elements 230. The outer frame 210 is fixed to the housing base 220 via the connecting elements 230.

The connecting elements 230 may be, for example, screws, or pins, or any other connecting elements capable of fixing the outer frame 210 to the housing base 220. In the optical module 1, there are four connecting elements 230, but the number of the connecting elements are not limited to four. There may be more or less connecting elements in other configurations. A housing space is formed between the outer frame 210 and the housing base 220, the components of the optical module 1, such as the movable part 100, the intermediate assembly 400, and the driving assembly 300, is accommodated inside the housing space. In another word, the movable part 100 moves inside the fixed part 200.

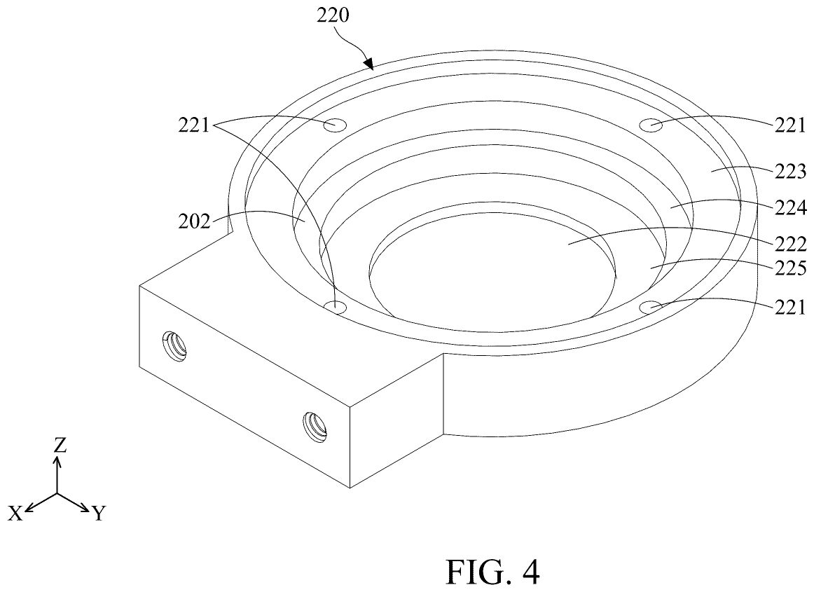

Next, please refer to FIG. 3 and FIG. 4 together. FIG. 3 is a perspective bottom view of the outer frame 210 of the optical module 1, according to certain aspects of the present disclosure. FIG. 4 is a perspective view of the housing base 220 of the optical module 1, according to certain aspects of the present disclosure.

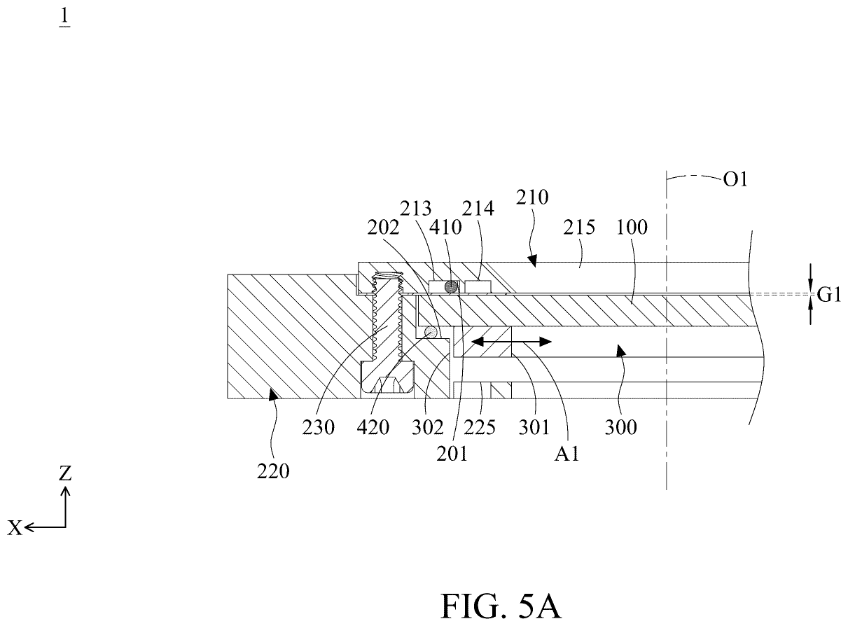

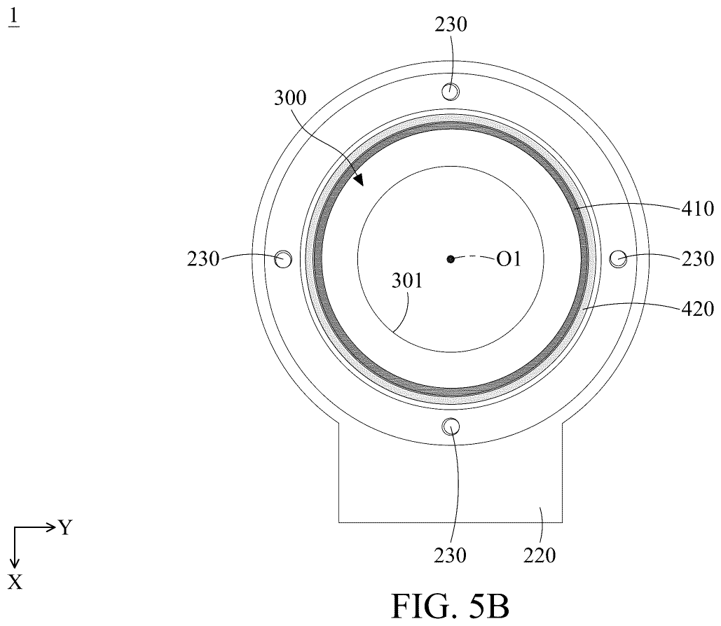

In the optical module 1, the first surface 201 is formed on the outer frame 210 while the second surface 202 is formed on the housing base 220. The first surface 201 faces the housing base 220, while the second surface 202 faces the outer frame 210. In another word, the first surface 201 and the second surface 202 face different directions. This will be explained further below with respect to FIG. 5A.

Next, please refer to FIG. 3. The outer frame 210 includes a plurality of screw holes 211, an opening 212, a first groove 213, a second groove 214, and a sloped surface 215 (shown in FIG. 2). The plurality of screw holes 211 is for accommodating the plurality of connecting elements 230. The opening 212 corresponds to the optical axis O1. The incident light passes through the opening 212. The first groove 213 is optionally for accommodating waterproof adhesive. Disposing waterproof adhesive between the outer frame 210 and the movable part 100 may prevent the dust or water from entering the optical module 1. The second groove 214 is for accommodating a first intermediate element 410 (shown in FIG. 2) of the intermediate assembly 400. The sloped surface 215 allows the dust or water that cover the optical module 1 to exit the outer frame 210 more easily.

Next, please refer to FIG. 4. The housing base 220 includes a plurality of screw holes 221, an opening 222, a first stage 223, a second stage 224, and a bottom stage 225. The plurality of screw holes 221 is for accommodating the plurality of connecting elements 230. The opening 222 corresponds to the optical axis O1. The incident light passes through the opening 222. The first stage 223 is for placing the outer frame 210 (shown in FIG. 2 and FIG. 3). The second stage 224 is for placing a second intermediate element 420 (shown in FIG. 2) of the intermediate assembly 400. The bottom stage 225 is for disposing the driving assembly 300. The driving assembly 300 is connected to the bottom stage 225 via a non-conductive gel that prevents the particles from entering the optical module 1.

Next, please refer back to FIG. 2. The intermediate assembly 400 includes a first intermediate element 410 and a second intermediate element 420. The first intermediate element 410 is placed between the first surface 201 and the movable part 100. The second intermediate element 420 is placed between the second surface 202 and the movable part 100.

Next, please refer to FIG. 2, FIG, 5A, and FIG. 5B together. FIG. 5A is a cross-sectional view of the optical module 1 along line B-B in FIG. 1, according to certain aspects of the present disclosure.

FIG. 5B is a top view of the optical module 1, according to certain aspects of the present disclosure, wherein the outer frame 210 and the movable part 100 are removed for illustrative purposes.

The driving assembly 300 includes an inner surface 301 and an outer surface 302. The inner surface 301 faces the optical axis O1. The inner surface 301 and the outer surface 302 face different directions. In another word, the outer surface 302 face the opposite direction to the optical axis O1.

The material of the driving assembly 300 may include piezoelectric material. When an electric field (voltage) is applied to the surface of a piezoelectric material, the electric dipole moment will be elongated due to the action of the electric field. In order to resist the changes in the electric dipole moment, the piezoelectric material will elongate in the direction of the electric field, so that it produces mechanical deformation, thereby driving the driving assembly 300 and the movable part 100 to move.

In the optical module 1, the electric dipole moment of the driving assembly 300 may be designed to extend on the XY-plane, around the optical axis O1, as marked by the arrow A1 in FIG. 5A. This movement drives the movable part 100 to move along the arrow A1. In another word, when the driving assembly 300 produces a driving force for driving the movable part 100 to move, the direction of the driving force, which is parallel to the arrow A1, is parallel to the first surface 201.

The intermediate assembly 400 includes the first intermediate element 410 and the second intermediate element 420. The first intermediate element 410 and the second intermediate element 420 are made of flexible material, such as silicone. The flexible characteristics of the first intermediate element 410 and the second intermediate element 420 enables them to press against the movable part 100, forming sealed edges between them. This prevents the particles and water from entering the optical module 1.

In the optical module 1, the first intermediate element 410 is disposed on the first surface 201 on the outer frame 210, and the second intermediate element 420 is disposed on the second surface 202 on the housing base 220.

The movable part 100 is driven by the movement of the driving assembly 300 to move relative to the fixed part 200 via the first intermediate element 410 and the second intermediate element 420. When the driving assembly 300 extends on the XY-plane, around the optical axis O1, or along the direction of the arrow A1, the movable part 100 is driven to move. With the movement of the movable part 100, the external particles on the movable part 100 is shaken off the surface of the movable part 100, and then exit the optical module 1 along the sloped surface 215 of the outer frame 210. A gap G1 is between the outer frame 210 and the movable part 100 so the movable part 100 does not contact the fixed part 200 when moving.

When viewed along the optical axis O1, the first intermediate element 410 and the second intermediate element 420 are not located between the optical axis O1 and the inner surface 301. In another word, the first intermediate element 410 and the second intermediate element 420 are located outside of the inner surface 301.

In the optical module 1, the second intermediate element 420 does not overlap the driving assembly 300. As a result, when viewed along the optical axis O1, at least one of the first intermediate element 410 and the second intermediate element 420 do not overlap the driving assembly 300. In the optical module 1, the first intermediate element 410 partially overlaps the outer surface 302 of the driving assembly 300. As a result, when viewed along the optical axis O1, at least one of the first intermediate element 410 and the second intermediate element 420 (in the optical module 1, the first intermediate element 410) at least partially overlap the driving assembly 300.

In the optical module 1, when viewed from a direction perpendicular to the first surface 201, for example, when viewed from the optical axis O1 (the view from FIG. 5B), at least part of the first intermediate element 410 does not overlap the second intermediate element 420. In another word, the first intermediate element 410 does not completely overlap the second intermediate element 420.

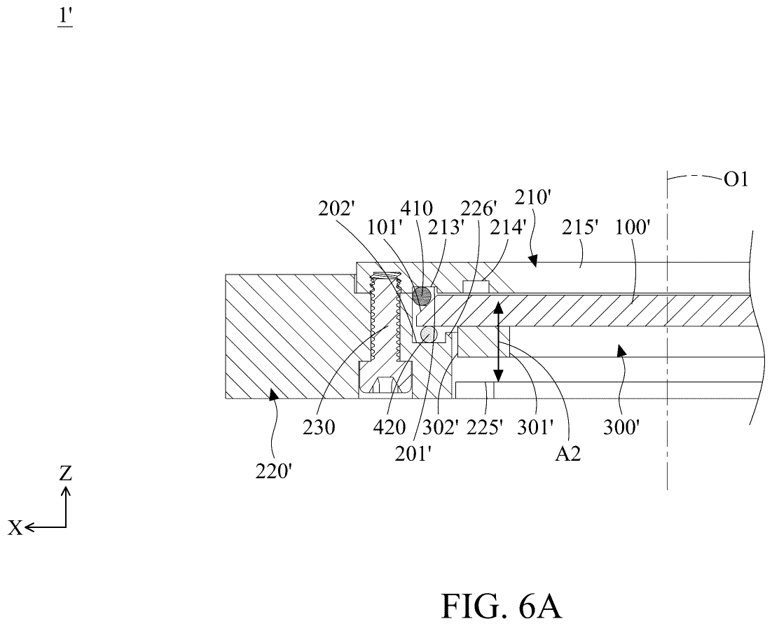

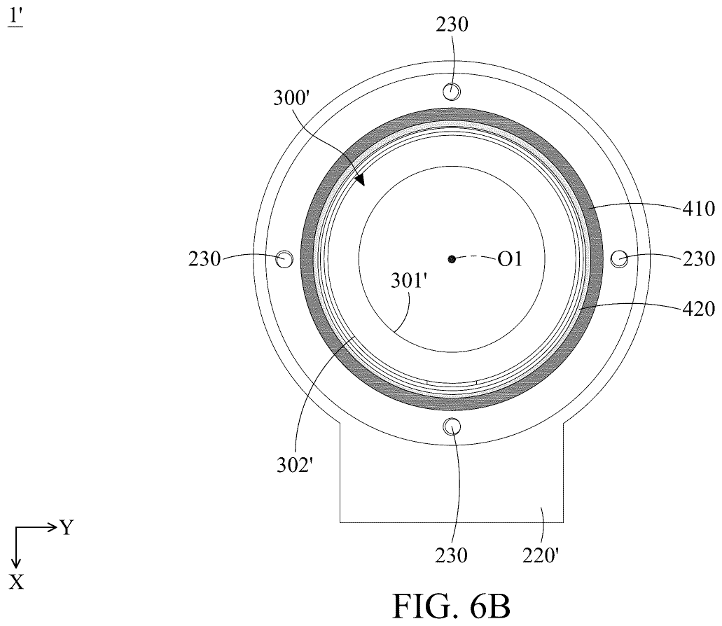

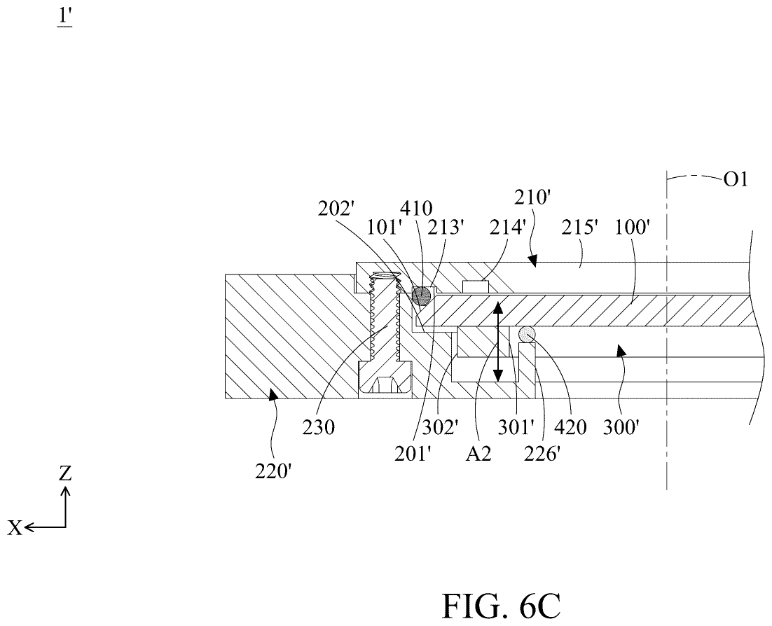

FIG. 6A is a cross-sectional view of another embodiment of the optical module 1′ along line B-B in FIG. 1, according to other aspects of the present disclosure.

FIG. 6B is a top view of the optical module 1′, according to certain aspects of the present disclosure, wherein the outer frame 210′ and the movable part 100′ are removed for illustrative purposes.

The optical module 1′ is generally similar to the optical module 1, wherein the like components are designated with the same reference numbers.

In the optical module 1′, the movable part 100′ has a chamfered edge 101′. The chamfered edge 101′ directly contacts the first intermediate element 410. The first intermediate element 410 contacts the movable part 100′, the outer frame 210′ and the housing base 220′. The chamfered edge 101′ corresponds to the first intermediate element 410. The chamfered edge 101′ is not parallel or perpendicular to the first surface 201′. The first intermediate element 410 contacts the chamfered edge 101′, the outer frame 210′ and the housing base 220′. The housing base 220′ of the optical module 1′ further includes a protruding wall 226′ that prevents the particles from entering the optical module 1′. In the embodiment shown in FIG. 6A, the protruding wall 226′ is located between the second intermediate element 420 and the driving assembly 300′ when viewed along the optical axis O1.

Please refer to FIG. 6C next. FIG. 6C is a cross-sectional view of another embodiment of the optical module 1′ along line B-B in FIG. 1, according to other aspects of the present disclosure. In the embodiment shown in FIG. 6C, the protruding wall 226′ and the second intermediate element 420 is be disposed adjacent to the inner surface 301, between the inner surface 301 and the optical axis O1, this prevents the particles from interfering with the optical module 1′. The second intermediate element 420 contacts the movable part 100′ and the protruding wall 226′. When viewed along the optical axis O1, the second intermediate element 420 and the protruding wall 226′ are located between the optical axis O1 and the inner surface 301′. Please refer back to FIG. 6A. In the optical module 1′, the electric dipole moment of the driving assembly 300′ is designed to extend on the Z axis, parallel to the optical axis O1, as marked by the arrow A2 in FIG. 6A. This movement drives the movable part 100′ to move along the arrow A2. In another word, when the driving assembly 300′ produces a driving force for driving the movable part 100′ to move, the direction of the driving force, which is parallel to the arrow A2, is perpendicular to the first surface 301′.

The movable part 100′ is driven by the movement of the driving assembly 300′ to move relative to the outer frame 210′ and the housing base 220′ via the first intermediate element 410 and the second intermediate element 420. When the driving assembly 300′ extends on the Z axis, along the optical axis O1, or along the direction of the arrow A2, the movable part 100′ is driven to move. With the movement of the movable part 100′, the external particles on the movable part 100′ is shaken off the surface of the movable part 100′, and then exit the optical module 1′ along the sloped surface 215′ of the outer frame 210′.

In the optical module 1′, when viewed from a direction perpendicular to the first surface 201′, for example, when viewed from the optical axis O1 (the view from FIG. 5B), at least part of the first intermediate element 410 does not overlap the second intermediate element 420. In another word, the first intermediate element 410 does not completely overlap the second intermediate element 420.

When viewed along the optical axis O1, the first intermediate element 410 and the second intermediate element 420 are not located between the optical axis O1 and the inner surface 301′. In another word, the first intermediate element 410 and the second intermediate element 420 are located outside of the inner surface 301′.

In the optical module 1′, the first intermediate element 410 and the second intermediate element 420 do not overlap the driving assembly 300′. As a result, when viewed along the optical axis O1, at least one of the first intermediate element 410 and the second intermediate element 420 do not overlap the driving assembly 300′.

In another optical module 1′, the first intermediate element 410 partially overlaps the outer surface 302′ of the driving assembly 300′. As a result, when viewed along the optical axis O1, at least one of the first intermediate element 410 and the second intermediate element 420 (in the optical module 1′, the first intermediate element 410) at least partially overlap the driving assembly 300.

In another embodiment of the optical module 1′ where the second intermediate element 420 and the protruding wall 226′ is located between the optical axis O1 and the inner surface 301′ of the driving assembly 300′, when viewed along the optical axis O1, both the first intermediate element 410 and the second intermediate element 420 do not overlap the driving assembly 300′.

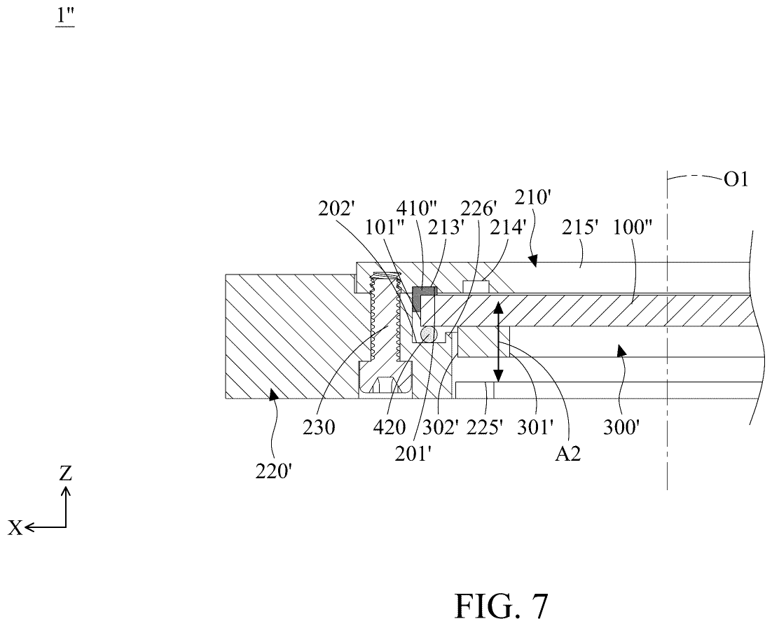

FIG. 7 is a cross-sectional view of another optical module 1″ along line B-B in FIG. 1, according to other aspects of the present disclosure.

The optical module 1″ is generally similar to the optical module 1′, wherein the like components are designated with the same reference numbers.

In the optical module 1″, the housing base 220′ also includes a protruding wall 226′. The protruding wall 226′ is located between the second intermediate element 420 and the driving assembly 300′ when viewed along the optical axis O1. The movable part 100″ directly contacts the first intermediate element 410″. The first intermediate element 410 contacts the movable part 100″, the outer frame and 210′ the housing base 220′.

The first intermediate element 410″ has a L-shaped cross-section, corresponding to the profile of the movable part 100″. This buffers the movement of the movable part 100″, reducing the probability of damaging.

In the optical module 1″, the first intermediate element 410″ comprises a first portion and a second portion. The first portion is connected to the second portion. When viewed from a direction perpendicular to the first surface 201′, the first portion overlaps the movable part 100″, and the second portion does not overlap the movable part 100″.

The optical module disclosed herein is a lens cleaning module designed specifically for outdoor cameras. By utilizing controlled vibration movements, this module effectively removes dust, water droplets, and debris without the need for physical contact or additional cleaning agents. This ensures continuous and reliable operation in harsh environments, reducing maintenance costs and improving the longevity of outdoor camera systems.

In summary, the present disclosure discloses an optical module that includes a movable part, a fixed part, a driving assembly, and an intermediate assembly. The movement of the driving assembly drives the movable part to move relative to the fixed part. This allows for the controlled vibration of the movable part to remove the dust attached onto the optical module, thereby providing more stable optical quality. Additionally, the design of the intermediate assembly enables the movable part to be sealed to the fixed part, ensuring that no dust enters the optical module.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present invention have been described above, it should be understood that they have been presented by way of example only, and not limitation. Numerous changes to the disclosed embodiments may be made, according to the disclosure herein, without departing from the spirit or scope of the invention. Thus, the breadth and scope of the present invention should not be limited by any of the above-described embodiments. Rather, the scope of the invention should be defined, according to the following claims and their equivalents.

The terminology used herein is for the purpose of describing particular embodiments only and is not intended to be limiting of the invention. As used herein, the singular forms “a, an” and “the” are intended to include the plural forms as well, unless the context clearly indicates otherwise. In addition, the terms “including, includes”, “having, has, with” or variations thereof used in the embodiments and/or claims are intended to be similar to “comprising” is included.

What is claimed is:

1. An optical module, comprising:
a movable part;
a fixed part, wherein the movable part moves relative to the fixed part; and
a driving assembly, for driving the movable part to move relative to the fixed part.

2. The optical module as claimed in claim 1, wherein the fixed part includes:
a first surface; and
a second surface, wherein the first surface and the second surface face different directions.

3. The optical module as claimed in claim 2, further comprising an intermediate assembly, wherein the movable part moves relative to the fixed part via the intermediate assembly, and the intermediate assembly includes:
a first intermediate element, disposed between the first surface and the movable part; and
a second intermediate element, disposed between the second surface and the movable part.

4. The optical module as claimed in claim 3, wherein the fixed part further includes:
an outer frame, including an opening corresponding to an optical axis, wherein the first surface is formed on the outer frame; and
a housing base, wherein the second surface is formed on the housing base.

5. The optical module as claimed in claim 4, further comprising a gap between the outer frame and the movable part.

6. The optical module as claimed in claim 5, wherein when viewed from a direction perpendicular to the first surface, at least part of the first intermediate element does not overlap the second intermediate element.

7. The optical module as claimed in claim 5, wherein the driving assembly includes:
an inner surface, facing the optical axis; and
an outer surface, wherein the inner surface and the outer surface face different directions.

8. The optical module as claimed in claim 7, wherein when viewed along the optical axis, the first intermediate element and the second intermediate element are not located between the optical axis and the inner surface.

9. The optical module as claimed in claim 8, wherein when the driving assembly produces a driving force for driving the movable part to move, the direction of the driving force is parallel to the first surface.

10. The optical module as claimed in claim 8, wherein when viewed along the optical axis, at least one of the first intermediate element and the second intermediate element do not overlap the driving assembly.

11. The optical module as claimed in claim 8, wherein when viewed along the optical axis, at least one of the first intermediate element and the second intermediate element at least partially overlap the driving assembly.

12. The optical module as claimed in claim 7, wherein when viewed along the optical axis, the first intermediate element is not located between the optical axis and the inner surface.

13. The optical module as claimed in claim 12, wherein when the driving assembly produces a driving force for driving the movable part to move, the direction of the driving force is perpendicular to the first surface.

14. The optical module as claimed in claim 12, wherein when viewed along the optical axis, the first intermediate element does not overlap the driving assembly.

15. The optical module as claimed in claim 12, wherein the housing base further comprises a protruding wall, the second intermediate element contacts the movable part and the protruding wall;
when viewed along the optical axis, the second intermediate element and the protruding wall are located between the optical axis and the inner surface.

16. The optical module as claimed in claim 12, wherein when viewed along the optical axis, the first intermediate element at least partially overlaps the driving assembly.

17. The optical module as claimed in claim 7, wherein the housing base further comprises a protruding wall, the protruding wall is located between the second intermediate element and the driving assembly when viewed along the optical axis.

18. The optical module as claimed in claim 4, wherein the first intermediate element comprises a first portion and a second portion;
the first portion is connected to the second portion;
when viewed from a direction perpendicular to the first surface, the first portion overlaps the movable part;
when viewed from a direction perpendicular to the first surface, the second portion does not overlap the movable part.

19. The optical module as claimed in claim 18, wherein the first intermediate element contacts the movable part, the outer frame and the housing base.

20. The optical module as claimed in claim 4, wherein the movable part comprises a chamfered edge corresponding to the first intermediate element;
the chamfered edge is not parallel or perpendicular to the first surface; the first intermediate element contacts the chamfered edge, the outer frame and the housing base.
